(19) United States
(12) Patent Application Publication
(10) Pub. No.: US 2020/0231787 A1
(43) Pub. Date: Jul. 23, 2020

(54) TIRE WITH COMPONENT OF SILICA REINFORCED RUBBER COMPOSITION CONTAINING SPECIALIZED STYRENE/BUTADIENE ELASTOMER AND VEGETABLE OIL AND TRACTION RESIN

(71) Applicant: The Goodyear Tire & Rubber Company, Akron, OH (US)

(72) Inventors: Lauren Elizabeth Brace, Chagrin Falls, OH (US); Brad Stephen Gulas, Fairlawn, OH (US); Kate Elizabeth Dennis-Pelcher, Uniontown, OH (US)

(21) Appl. No.: 16/254,885

(22) Filed: Jan. 23, 2019

(51) Int. Cl. C08L 9/06; B60C 1/00

(52) U.S. Cl. CPC C08L 9/06; B60C 1/0016; C08L 2205/06; C08L 2205/035; C08L 2205/025

(57) ABSTRACT

The invention relates to a tire having a component, particularly a circumferential tread, of a rubber composition containing precipitated silica reinforcement, vegetable oil, specialized styrene/butadiene elastomer having a molecular weight profile containing a limited low molecular weight content and traction promoting resin.

### FIELD OF THE INVENTION

The invention relates to a tire having a component, particularly a circumferential tread, of a rubber composition containing precipitated silica reinforcement, vegetable oil, specialized styrene/butadiene elastomer having a molecular weight profile containing a limited low molecular weight content and traction promoting resin.

### BACKGROUND OF THE INVENTION

Tires are sometimes provided with one or more components, such as a tread, of a rubber composition comprised of at least one conjugated diene-based elastomer which includes a styrene/butadiene elastomer for which the rubber composition contains a significant reinforcing filler content comprised primarily of precipitated silica.

The styrene/butadiene elastomer may, for example, be a functionalized styrene/butadiene elastomer containing functional groups reactive with hydroxyl groups contained on the precipitated silica.

However, it is desired to evaluate the use of a specialized styrene/butadiene elastomer without containing functional groups reactive with hydroxyl groups on the precipitated silica where the specialized styrene/butadiene elastomer has a molecular weight profile restricted to having a low molecular weight content limited to a maximum of six percent of weight average molecular weight (Mw) of up to 150,000 for a precipitated silica reinforced rubber composition.

For such evaluation, such rubber composition containing the specialized styrene/butadiene elastomer contains rubber processing oil comprised of freely added triglyceride vegetable oil (rubber processing oil added to the rubber composition).

Representative of such triglyceride vegetable oils are, for example, soybean oil, sunflower oil, rapeseed oil, particularly soybean oil.

In one embodiment, said rubber composition also contains a petroleum based rubber processing oil. The petroleum based rubber processing oil may be a freely added oil and/or a rubber extending oil. (Rubber extending oil is an oil added to the elastomer itself at the elastomer production facility.)

It is additionally desired, for such evaluation, to provide such rubber composition with at least one traction promoting resin.

While a mechanism might not be fully understood, it is theorized that the presence of a restrictive low molecular weight content in a styrene/butadiene elastomer can promote absorbing greater energy within the elastomer. Such energy absorption may thereby contribute to promoting a higher hysteresis of the cured rubber composition, as may be evidenced by one or more of its increased rebound and reduced tangent delta physical properties, and thereby promote higher heat generation within the rubber composition, or tire component, during tire service. It is envisioned that, however, a lower content of low molecular weight portion of the elastomer might beneficially promote less internal heat generation within the rubber composition during its dynamic use and an associated beneficial reduction in the rubber composition's hysteresis. Therefore the aforesaid evaluation is to be undertaken.

In the description of this invention, terms such as “compounded rubber”, “rubber compound” and “compound”, if used herein, refer to rubber compositions containing elastomers blended with various ingredients, including curatives such as sulfur and cure accelerators. The terms “elastomer” and “rubber” may be used herein interchangeably unless otherwise indicated. It is believed that such terms are well known to those having skill in such art. The molecular weight of an elastomer may be determined, for example, by Gel Permeation Chromatography as would be understood as being well known by those having skill in such art.

### DISCLOSURE AND PRACTICE OF THE INVENTION

In accordance with this invention, a pneumatic rubber tire is provided having a component of a rubber composition containing, based on parts by weight per 100 parts by weight of the rubber (phr),

(A) conjugated diene-based elastomers comprised of:
(1) about 40 to about 90, alternately about 60 to about 80 phr (such alternative range is therefore a majority of the elastomers) of a specialized styrene/butadiene elastomer having a molecular weight profile comprised of a weight average molecular weight (Mw) in a range of from about 500,000 to about 800,000 with a low molecular weight content limited to a maximum of six, alternately to a maximum of about 5.5, percent (weight percent) of said styrene/butadiene elastomer having a number average molecular weight (Mw) of up to 150,000, (for example such limited (restrictive) molecular weight content may have a number average molecular weight within a range of from about 100 to about 150,000), and
(2) about 60 to about 10, alternately about 40 to about 20, phr (such an alternate range is therefore a minority of the elastomers) of at least one additional conjugated diene-based elastomer,

(B) about 40 to about 160, alternately about 40 to about 140, phr of reinforcing filler comprised of a combination of rubber reinforcing carbon black and precipitated silica (e.g. where the reinforcing filler contains from about 10 to about 99.5, alternately about 50 to about 96, weight percent precipitated silica and from about 0.5 to about 90 (alternately about 4 to about 50) weight percent rubber reinforcing carbon black, alternately contains at least 100 phr of precipitated silica and limited to containing up to about 15, alternately up to 5, such as for example form about 1 to about 15, phr of rubber reinforcing carbon back) wherein a coupling agent is provided for said precipitated silica having a moiety reactive or interactive with hydroxyl groups (e.g. silanol groups) on said precipitated silica and another different moiety reactive or interactive with said diene-based elastomers,

(C) about 5 to about 70, alternately about 9 to about 40, phr of traction promoting resin, and

(D) about 15 to about 55, alternately about 9 to about 40 phr of at least one rubber processing oil comprised of at least one triglyceride vegetable oil. For example, said triglyceride vegetable oil may be comprised of at least one of soybean oil, sunflower oil and rapeseed oil, particularly soybean oil.

In one embodiment, said triglyceride vegetable oil is a freely added rubber processing oil.

In one embodiment said rubber composition contains a combination of such triglyceride vegetable rubber processing oil and at least one petroleum based rubber processing oil. Such petroleum based rubber processing oil may be a rubber extension oil (to provide, for example, an oil extended specialized styrene/butadiene rubber) or a freely added oil to the rubber composition. Representative of such petroleum based rubber processing oils are, for example, at least one of naphthenic, paraffinic and aromatic oils or their combination.

In one embodiment, said rubber composition contains an additional precipitated silica added without additional silica coupler.

In one embodiment, said rubber composition contains an additional silica coupler without additionally added precipitated silica.

In one embodiment, said coupling agent is comprised of an alkoxyorganomercaptosilane or an bis(3-triethoxysilylpropyl) polysulfide having an average of from about 2 to about 4 connecting sulfur atoms in its polysulfidic bridge.

The bis(3-triethioxysilylpropyl) polysulfide may have, for an example, an average of from about 2 to about 2.6 or about 3 to about 4 (e.g. about 3.4 to about 3.8), connecting sulfur atoms in its polysulfidic bridge.

In one embodiment, said precipitated silica and coupling agent are provided as a composite of said precipitated silica pre-treated (pre-hydrophobated) with said coupling agent prior to addition thereof to the rubber composition. In such embodiment, said coupling agent may desirably be, for example, said alkoxyorganomercaptosilane.

In one embodiment, said precipitated silica and coupling agent are provided with said rubber composition to thereby provide in situ treatment of (reaction with) said precipitated silica within said rubber composition (instead of being pre-reacted to form a composite before addition to the rubber composition). In such embodiment for such in situ treated precipitated silica, said coupling agent may desirably be, for example, said bis (3-triethoxysilylpropyl) polysulfide.

In one embodiment, particularly where the rubber composition contains a high content of at least 100 phr of precipitated silica as the reinforcing filler, usually with a minimal rubber reinforcing carbon black of an amount of up to 15, usually up to 10 and optionally only up to about 5 or 6 phr, a significant amount of rubber processing oil is used, namely at least one of said petroleum based and triglyceride vegetable oil or mixtures thereof. For example, U.S. Pat. No. 7,335,692 refers to rubber processing oil as a plasticizer for rubber compositions, presumably as plasticizers for uncured (unvulcanized) rubber compositions. In practice, it is usually desired for this application that other materials said to be useful as rubber plasticizers such as, for example, trioctyl phosphate and compositions based on synthetic diglyceridal fatty acids, are not used.

In addition, thermoplastic traction promoting resins for rubber compositions might sometimes also be referred to as a plasticizer in a sense of assisting the processing of uncured rubber compositions

For this rubber composition, in one embodiment the total of such combination of rubber processing oil and thermoplastic traction promoting resin in the rubber composition may be at amount of greater than 50 phr.

In another embodiment, such total may be provided in a an amount of up to 50 phr such as, for example, in a range of from about 40 to about 49 or even to 50 phr.

In further accordance with this invention said rubber composition is provided as a sulfur cured (sulfur vulcanized) rubber composition.

In one embodiment, the said specialized styrene/butadiene elastomer and conventional styrene/butadiene elastomers (organic solvent solution polymerization prepared elastomers) have similar ranges of Tg's such as for example a range of from about 20 to about 30° C. (e.g. about 23° C.).

In one embodiment, said specialized styrene/butadiene elastomer has a heterogeneity index (Mw/Mn) in a range of from about 1.5/1 to about 1.8/1.

The aforesaid molecular weight characterization of the specialized styrene/butadiene elastomer (ASTM D4001-13) may be carried out using an Agilent 1260 GPC (gel permeation chromatography) system equipped with an Agilent 1260 VWD ultraviolet detector, and Wyatt Technology Light Scattering, Viscosity, and Refractive index detectors with tetrahydrofuran as the mobile phase.

In practice, such tire component may be, for example, and not intended to be limiting, a tire tread. The tread component of the tire is a circumferential tire tread intended to be capable of being ground-contacting.

Therefore, in further accordance with this invention, a tire is provided having a circumferential tread comprised of said rubber composition.

In practice, suitable rubber reinforcing carbon blacks may be found, for example, in The Vanderbilt Rubber Handbook, (1990), 13th edition, Pages 416 through 419.

In one embodiment, said additional conjugated diene-based elastomers may be, for example, elastomers comprised of at least one of isoprene and 1,3-butadiene and of styrene and at least one of isoprene and 1,3-butadiene.

Representative of such additional conjugated diene-based elastomers may be, for example and not intended to be limiting, at least one of cis 1,4-polybutadiene, cis 1,4-polyisoprene, 3,4-polyisoprene and additional, conventional styrene/butadiene elastomers other than, or in addition to, said specialized styrene/butadiene elastomer having said limited molecular distribution (molecular weight profile). Said additional elastomers, including said specialized styrene/butadiene elastomer, are exclusive of elastomers containing functional groups reactive with hydroxyl groups on said precipitated silica.

The aforesaid specialized or additional conventional styrene/butadiene elastomer may, if desired, be tin or silicon coupled, more desirably tin coupled, to form a star-branched elastomer whereby its molecular weight is significantly increased.

In practice, specialized styrene/butadiene elastomer with molecular weight profile comprised of the restricted low molecular weight content has a bound styrene content in a range of from about 10 to about 40 weight percent. It (based on its polybutadiene portion) may have a vinyl 1,2-content in a range of from about 10 to about 60 percent of its isometric content (percent of the isomers).

For tin coupling of any of the styrene/butadiene elastomers, various organo tin compounds, may be used. Representative of such compounds are, for example, alkyl tin trichloride, dialkyl tin dichloride, yielding variants of a tin coupled styrene/butadiene copolymer elastomer.

The precipitated silica reinforcing filler is a synthetic amorphous silica such as, for example, a precipitated silica obtained by the acidification of a soluble silica silicate (e.g., sodium silicate or a co-precipitation of a silicate and an aluminate). Such precipitated silicas are, in general, well known to those having skill in such art. Representative of precipitated silica for use in this invention includes, for example, and not intended to be limitative, Zeosil 1165MP and 200MP from Solvay, Hi-Sil 135G-D and 233 from PPG Industries, EZ160G-D from PPG Industries, Zeopol 8755LS from Huber, Ultrasil VN 2 GR from Evonik. Representative of pre-treated (pre-hydrophobated) precipitated silica is, for example and not intended to be limitative, Agilon 400™ from PPG Industries. Representative examples of traction promoting resins are, for example, styrene-alphamethylstyrene resin, coumarone-indene resin, petroleum hydrocarbon resin, terpene polymer resin, terpene phenol resin, rosin derived resin, including gum rosin, and copolymers thereof and phenol formaldehyde resins, including octylphenol formaldehyde.

In one embodiment, the resin is a styrene/alphamethylstyrene resin. Such styrene/alphamethylstyrene resin may be, for example, a relatively short chain copolymer of styrene and alphamethylstyrene. In one embodiment, such a resin may be suitably prepared, for example, by cationic copolymerization of styrene and alphamethylstyrene in a hydrocarbon solvent. The styrene/alphamethylstyrene resin may have, for example, a styrene content in a range of from about 10 to about 90 weight percent. The styrene/alphamethylstyrene resin may have a softening point, for example, in a range of from about 60° C. to about 125° C., alternately from about 80° C. to 90° C. (ASTM E28). It might be referred to as having a Tg of at least 20° C., although it is considered herein to more desirably refer to a traction promoting resin by its softening point range. A suitable styrene/alphamethylstyrene resin may be, for example, Resin 2336™ from Eastman or Sylvares SA85™ from Arizona Chemical.

In one embodiment, the resin is a coumarone-indene resin. Such coumarone-indene resin may have a softening point, for example, in a range of from about 60° C. to about 150° C. containing coumarone and indene as the monomer components making up the resin skeleton (main chain). Minor amounts of monomers other than coumarone and indene may be incorporated into the skeleton such as, for example, methyl coumarone, styrene, alphamethylstyrene, methylindene, vinyltoluene, dicyclopentadiene, cycopentadiene, and diolefins such as isoprene and piperlyene.

In one embodiment, the resin is a petroleum hydrocarbon resin. Such petroleum hydrocarbon resin may be, for example, an aromatic and/or nonaromatic (e.g. paraffinic) based resin. Various petroleum resins are available. Some petroleum hydrocarbon resins have a low degree of unsaturation and high aromatic content, whereas some are highly unsaturated and yet some contain no aromatic structure at all. Differences in the resins are largely due to the olefins contained in the petroleum based feedstock from which the resins are derived. Conventional olefins for such resins include any C5 olefins (olefins and diolefines containing an average of five carbon atoms) such as, for example, cyclopentadiene, dicyclopentadiene, isoprene and piperylene, and any C9 olefins (olefins and diolefins containing an average of 9 carbon atoms) such as, for example, vinyltoluene and alphamethylstyrene. Such resins may be made from mixtures of such C5 and C9 olefins.

In one embodiment, said resin is a terpene resin. Such resin may be comprised of, for example, polymers of at least one of limonene, alpha pinene and beta pinene and having a softening point in a range of from about 60° C. to about 160° C.

In one embodiment, the resin is a terpene-phenol resin. Such terpene-phenol resin may be, for example, a copolymer of phenolic monomer with a terpene such as, for example, limonene and pinene.

In one embodiment, the resin is a resin derived from rosin and derivatives. Representative thereof are, for example, gum rosin and wood rosin. Gum rosin and wood rosin have similar compositions, although the amount of components of the rosins may vary. Such resins may be in the form of esters of rosin acids and polyols such as pentaerythritol or glycol.

In one embodiment, said rosin may be partially or fully hydrogenated.

In one embodiment, the resin is a phenol formaldehyde resin, such as, for example, octylphenol formaldehyde. Such resin may have, for example, a softening point in a range of from about 60 to about 95° C. (e.g. about 75 to about 92° C.)

The precipitated silica reinforcement may, for example, be characterized by having a BET surface area, as measured using nitrogen gas, in the range of, for example, about 40 to about 600, and more usually in a range of about 50 to about 300 square meters per gram. The BET method of measuring surface area might be described, for example, in the Journal of the American Chemical Society, Volume 60, as well as ASTM D3037.

Such precipitated silicas may, for example, also be characterized by having a dibutylphthalate (DBP) absorption value, for example, in a range of about 100 to about 400, and more usually about 150 to about 300 cc/100 g.

Various commercially available precipitated silicas may be used, such as, and not intended to be limiting, silicas from PPG Industries under the Hi-Sil trademark with designations 210, 243, 315, etc.; silicas from Solvay with, for example, designations of Zeosil 1165MP and Zeosil 165GR; silicas from Evonik with, for example, designations VN2 and VN3; and chemically treated (pre-hydrophobated) precipitated silicas such as for example Agilon™ 400 from PPG.

It is readily understood by those having skill in the art that the rubber compositions of the tread would be compounded with conventional compounding ingredients including the aforesaid reinforcing fillers such as carbon black and precipitated silica, as hereinbefore described, as well as antidegradant(s), processing oils, fatty acid comprised of, for example, stearic, oleic and palmitic acids and zinc oxide.

Processing aids may be used, for example, waxes such as microcrystalline and paraffinic waxes, in a range, for example, of about 1 to 5 phr or about 1 to about 3 phr; and resins, usually as tackifiers, such as, for example, synthetic hydrocarbon and natural resins in a range of, for example, about 1 to 5 phr or about 1 to about 3 phr. A curative might be classified as sulfur together with one or more sulfur cure accelerator(s). In a sulfur and accelerator(s) curative, the amount of sulfur used may be, for example, from about 0.5 to about 5 phr, more usually in a range of about 0.5 to about 3 phr; and the accelerator(s), often of the sulfenamide type, is (are) used in a range of about 0.5 to about 5 phr, often in a range of about 1 to about 2 phr. The ingredients, including the elastomers but exclusive of sulfur and accelerator curatives, are normally first mixed together in a series of at least two sequential mixing stages, although sometimes one mixing stage might be used, to a temperature in a range of, for example, about 145° C. to about 185° C., and such mixing stages are typically referred to as non-productive mixing stages. Thereafter, the sulfur and accelerators, and possibly one or more retarders and possibly one or more antidegradants, are mixed therewith to a temperature of, for example, about 90° C. to about 120° C. and is typically referred to as a productive mix stage. Such mixing procedure is well known to those having skill in such art.

After mixing, the compounded rubber can be fabricated such as, for example, by extrusion through a suitable die to form a tire tread. The tire tread is then typically built onto a sulfur curable tire carcass and the assembly thereof cured in a suitable mold under conditions of elevated temperature and pressure by methods well-known to those having skill in such art.

The invention may be better understood by reference to the following example in which the parts and percentages are by weight unless otherwise indicated.

### EXAMPLE I

This example illustrates production of a specialized styrene-butadiene rubber. A 15 percent monomer solution in hexanes (premix) is prepared by mixing styrene and 1,3-butadiene at a weight ratio of 30/70. The premix is then dried over desiccant such silica gel, alumina or molecular sieves. Polymerization is carried out in a two reactor process where the premix, initiator and modifier are continuously fed to the first reactor. Typical loading of initiator is 0.025 phm n-butyl lithium and typical loading of modifier is 0.1 phm 2,2-di(2-tetrahydrofuryl)propane (DTP). Polymerization is typically out at 60° C. and a total residence time of 90 minutes. A gel inhibitor (1,2-butadiene) is also added continuously at 60 ppm (based on total monomer). Polymerization is terminated with 1 phr stearic acid and stabilized with 0.5 phr Polystay K antioxidant. Typical properties for the specialized styrene/butadiene rubber are a bound styrene content of 30 percent by weight, a vinyl content of about 41 percent by weight and a molecular weight profile comprised of an overall weight average molecular weight (Mw) of about 535,000 with only about four percent thereof having a weight average molecular weight (Mw) of up to about 150,000 and a heterogeneity (polydispersity) index (Mw/Mn), weight average molecular weight to number average molecular weight, of about 1.5/1.

### EXAMPLE II

Rubber compositions were prepared to evaluate various styrene/butadiene elastomers for use with precipitated silica together with traction (tire tread traction) promoting resin and vegetable oil. The precipitated silica and coupling agent are reacted together in situ within the rubber composition.

Comparative rubber Sample A is presented for comparative purposes only on a basis that its styrene/butadiene is a functionalized elastomer identified herein as “functionalized styrene/butadiene rubber (A1)” together with precipitated silica reinforcement and traction promoting resin.

Control rubber Sample B contained a conventional, non-functionalized styrene/butadiene rubber (A2) having a molecular weight profile comprised of a weight average molecular weight (Mw) of about 650,000 with about 7.5 percent thereof having a weight average molecular weight (Mw) of less than about 150,000, together with precipitated silica and traction promoting resin.

Experimental rubber Samples C and D contained a non-functionalized specialized styrene/butadiene rubber having a molecular weight profile comprised of a weight average molecular weight (Mw) of about 535,000 (experimental styrene/butadiene rubber B1) with less than 4 percent thereof having a weight average molecular weight (Mw) of less than about 150,000, together with precipitated silica and traction promoting resin.

Both of experimental rubber Samples C and D contained extender petroleum based processing oil introduced into the elastomer at its manufacturing plant.

Experimental rubber Sample C also contained petroleum based processing oil freely added to the rubber composition.

Experimental rubber Sample D also contained soybean oil (a vegetable processing oil) freely added to the rubber composition instead of the freely added petroleum based processing oil of experimental rubber Sample C.

A summary of the rubber Sample formulations is illustrated in the following Table 1 which is presented in terms of parts per 100 parts by weight of rubber (phr).

As previously indicated, the rubber compositions may be prepared by mixing the elastomers(s) without sulfur and sulfur cure accelerators in a first non-productive mixing stage (NP-1) in an internal rubber mixer for about 4 minutes to a temperature of about 160° C. If desired, the rubber mixture may then be mixed in a second non-productive mixing stage (NP2) in an internal rubber mixer for about 4 minutes to a temperature of about 160° C. while adding additional ingredients if desired. The resulting rubber mixture may then be mixed in a productive mixing stage (PR) in an internal rubber mixer with sulfur and sulfur cure accelerator(s) for about 2 minutes to a temperature of about 110° C. The rubber composition may be sheeted out and cooled to below 50° C. between each of the non-productive mixing steps and prior to the productive mixing step. Such rubber mixing procedure is well known to those having skill in such art.

TABLE 1

| | Parts (phr) |
|---|---|
| Non-Productive Mixing Step (NP) - Mixed to 160° C. | |
| Cis 1,4-polybutadiene rubber¹ | 30 |
| Comparative functionalized styrene/butadiene SBR elastomer A1^{2,} | 0 and 70 |
| Control conventional styrene/butadiene SBR elastomer A2³ | 0 and 70 |
| Specialized styrene/butadiene rubber B1⁴ | 0 and 70 |
| Petroleum based extending oil contained in control and specialized SBR | 0, 26, 14 |
| Freely added petroleum based oil contained in comparative and control SBRs⁵ | 30, 9.8 |
| Freely added soybean oil for specialized SBR-containing rubber composition | 0.22 |
| Precipitated silica⁶ | 110 |
| Silica coupling agent⁷ | 9 |
| Traction promoting resin⁸ | 15 |
| Fatty acid⁹ | 3 |
| Rubber reinforcing carbon black¹⁰ | 5 |
| Zinc oxide | 1.8 |
| Wax, microcrystalline and/or paraffinic | 2 |
| Antioxidant(s) | 3 |
| Productive Mixing Step (PR) - Mixed to 110° C. | |
| Sulfur | 1 |
| Accelerator(s)¹¹ | 5.5 |

¹Cis-1,4-polybutadiene rubber as BUD1207 from The Goodyear Tire and Rubber Company having a Tg of about −105° C.
²Comparataive organic solvent solution polymerization derived functionalized styrene/butadiene rubber (S-SBR-A1) as Sprintan SLR4602 from Trinseo having a bound styrene content of about 21 weight percent and vinyl-1,2-content of about 62 percent apparently containing aa combination of siloxy and thiol groups groups reactive with hydroxyl groups on said precipitated silica
³Control organic solvent solution polymerization derived styrene/butadiene (S-SBR-A2) as Solflex 30H41 from The Goodyear Tire and Rubber Company having a bound styrene content of about 30 weight percent and vinyl content of about 41 percent, a weight average molecular weight (Mw) of about 650,000 with about 7.5 percent thereof having a weight average Mw of less than about 150,000 and a heterogeneity (polydispersity) index (Mw/Mn) of about 1.8/1. The elastomer was petroleum oil extended with about 37.5 parts by weight oil per 100 parts by weight of the elastomer and is reported in the Table in parts by weight of the elastomer.
⁴Specialized organic solvent solution polymerization derived styrene/butadiene rubber (specialized SSBR) having a bound styrene of about 30 weight percent and vinyl content of about 41 percent and a molecular weight profile comprised of an overall weight average molecular weight (Mw) of about 535,000 with only about four percent thereof having a weight average Mw of up to about 150,000 and a heterogeneity (polydispersity) index (Mw/Mn) of about 1.49/1. The elastomer was petroleum oil extended with about 20 parts by weight oil per 100 parts by weight of the elastomer and is reported in the Table in parts by weight of the elastomer. The specialized SSBR was made following the procedure of Example 1.
⁵Freely added soybean oil as Cargill Master Chef Soybean Oil 22393
⁶Precipitated silica as Zeosil 1165 ™ from Solvay
⁷Silica coupling agent as Si266 ™ from Evonik as bis(3-triethoxysilylpropyl) polysulfide having an average of from 2 to about 2.6 connecting sulfur atoms in its polysulfidic bridge
⁸Traction promoting resin as styrene/alphamethylstyrene resin having a softening point of about 86° C. and a Tg of about 26° C. as Impera P1504 ™ from Eastman
⁹Fatty acid comprised of stearic, palmitic and oleic acids
¹⁰Rubber reinforcing carbon black as N330, an ASTM characterization
¹¹Sulfenamide and diphenyl guanidine sulfur cure accelerators

The following Table 2 represents the uncured and cure behavior and various physical properties of the rubber compositions. Test samples were cured for about 14 minutes at about 160° C.

TABLE 2

| | Samples | | | |
|---|---|---|---|---|
| | Control | | Experimental | |
| | A | B | C | D |
| Cis 1,4-polybutadiene rubber | 30 | 30 | 30 | 30 |
| Control (comparative) functionalized SBR A1 | 70 | 0 | 0 | 0 |
| Control (conventional) styrene/butadiene rubber A2 | 0 | 70 | 0 | 0 |
| Specialized (non-functionalized) styrene/butadiene | 0 | 0 | 70 | 70 |
| rubber B1 | | | | |
| Precipitated silica | 110 | 110 | 110 | 110 |
| Petroleum extender oil | 0 | 26.3 | 14 | 14 |
| Freely added petroleum oil | 30 | 9.8 | 22 | 0 |
| Freely added soybean oil | 0 | 0 | 0 | 22 |
| Traction promoting resin | 15 | 15 | 15 | 15 |
| Properties | | | | |
| Rubber processing indication (RPA¹), uncured storage | 0.25 | 0.20 | 0.22 | 0.22 |
| modulus G′, 15% strain 0.83 Hertz, 100° C. (MPa) | | | | |
| Rubber stiffness indication (RPA¹), cured storage modulus | 3.67 | 3.42 | 3.56 | 3.28 |
| G′ at 1% strain, 1 Hertz, 100° C., MPa (higher is better) | | | | |
| Rubber Hysteresis Indication | | | | |
| Tan delta at 10% strain, 1 Hertz, 100° C. (lower is better) | 0.159 | 0.166 | 0.167 | 0.177 |
| Rebound (Zwick), 100° C., % (higher is better) | 53.4 | 49.6 | 51.1 | 48.9 |
| Predictive Low Temperature Performance (ARES²) (lower is better) | | | | |
| Cured storage modulus G′ at −20° C., 3% strain, | | | | |
| 10 Hz (MPa) | 3.98E7 | 8.56E7 | 5.59E7 | 2.74E7 |
| Predictive Wet Traction Performance (ARES²) (higher is better) | | | | |
| Cured tan delta at 0° C., 3% strain, 10 Hz | 0.59 | 0.71 | 0.64 | 0.55 |
| Rubber Abrasion Resistance Indication⁴ | | | | |
| DIN abrasion relative volume loss (lower is better) | 86.5 | 108 | 97 | 91 |
| MDR³ test; 60 minutes at 150° C. | | | | |
| Delta torque (dN-m) | 16.3 | 14.8 | 15.3 | 13.6 |
| T90 (minutes) | 21.3 | 21.3 | 21.4 | 18.4 |
| T25 (minutes) | 10.9 | 11.0 | 11.3 | 9.9 |
| Stress-strain Properties | | | | |
| Tensile strength (MPa) | 15.7 | 15.4 | 15.9 | 15.9 |
| Elongation at break (%) | 450 | 574 | 630 | 696 |
| 300% modulus, (MPa) | 9.5 | 6.8 | 6.1 | 5.6 |
| Toughness = (tensile strength × elongation/ | 741 | 1304 | 1640 | 1993 |
| 300% modulus) (higher is tougher) | | | | |

From Table 2 it is observed that:

### (A) Uncured Rubber Sample Processing

The use of a functionalized SSBR in silica-filled Comparative rubber Sample A resulted in a higher uncured G′ storage modulus (0.25 MPa), probably because of the functional group reacting with the silica reinforcement, than that of Control rubber Sample B (0.20 MPa), which contained a conventional non-functionalized SSBR.

For silica-filled Experimental rubber Samples C and D containing the specialized styrene/butadiene rubber (specialized SSBR) with its specialized molecular weight profile, the uncured G′ storage modulus values of 0.22 MPa for both of Sample C with the freely petroleum based processing oil and Sample D with the freely added vegetable oil (soybean oil) were greater than the uncured G′ storage modulus value of Control rubber Sample B of 0.20 MPa based on a conventional styrene/butadiene rubber. This is an indication that the inclusion of the specialized styrene/butadiene rubbers in the rubber Samples C and D with their molecular weight profiles containing significantly reduced low molecular weight content increased the energy needed for processing the rubber Samples because of the associated greater higher molecular weight content compared to a more conventional styrene/butadiene rubber. However, the uncured G′ storage modulus values of Experimental Samples C and D (0.22 MPa) were still lower than that of Comparative rubber Sample A of 0.25 MPa which was based on containing a functionalized SSBR together with freely added petroleum based processing oil. This is considered to be a significant discovery of being able to provide the rubber composition with beneficial processing characteristic without the functionalized SSBR.

While the discovered result of inclusion of the specialized styrene/butadiene elastomer is not entirely understood, it is envisioned that the reduction in the lower molecular weight content of the styrene/butadiene elastomer increased the proportional content of the higher molecular weight molecule of the elastomer profile so that their polymer chain entanglements within the elastomers becomes a greater factor and promotes a higher storage modulus G′ for the uncured elastomers and rubber compositions.

### (B) Predictive Cold Weather, Wet Traction, and Treadwear Performances

(1) The storage modulus (G′) at −20° C. for a cured rubber composition is used an indicator of cold weather performance for a tire tread. Lower values are considered better for cold weather (e.g. with snow conditions performance for a tire tread of such rubber composition.

It is seen in Table 2 that cured Experimental silica-reinforced rubber Samples C and D containing the specialized styrene/butadiene rubber with its molecular weight profile, reported a cured G′ storage modulus value measured at −20° C. of 5.59E7 MPa for cured rubber Sample C containing freely added petroleum based processing oil and a beneficially significantly reduced value of 2.74E7 MPa at −20° C. for rubber Sample D where freely added soybean oil replaced the freely added petroleum based oil of rubber rubber Sample C. Additionally, the storage modulus (G′) for Experimental rubber Sample C was greater than the storage modulus (G′) value of 3.98E7 MPa for Comparative rubber Sample A but less than the storage modulus (G′) value of 8.56E7 for Control rubber Sample B. However the storage modulus (G′) for Experimental rubber Sample D (containing the free added soybean oil) was beneficially significantly lower than for Experimental rubber Sample C as well as for Comparative and Control rubber Samples A and B.

It is concluded that, with lower values of storage modulus G′ (at −20° C.) considered as being better for predictive cold weather performance for a tire having a tread of such rubber composition that:
(a) Experimental rubber Sample C with the specialized styrene/butadiene elastomer containing the freely added petroleum based processing oil exhibited a reduced predictive cold weather performance (snow performance) in a sense of lower stiffness at −20° C. of 5.59E7 compared to Comparative rubber Sample A with its stiffness value of 3.98E7.
(b) Experimental rubber Sample D with the specialized styrene/butadiene elastomer containing the freely added soybean oil exhibited a significantly and beneficially reduced storage modulus (G′), and therefore a significantly improved predictive cold weather performance in a sense of stiffness at −20° C. of 2.74E7 compared to Experimental rubber Sample C and also compared to both of Comparative and Control rubber Samples A and B.

Therefore, it is concluded that it was discovered that the inclusion of the freely added soybean oil for rubber Sample D enabled the rubber composition C containing the specialized styrene/butadiene rubber with its specialized molecular weight profile to achieve a beneficially improved predictive cold weather performance property.

(2) The tangent delta (tan delta) value at 0° C. is used as an indicator of wet traction performance for rubber composition for a a tire tread. Higher values are considered better for predictive wet traction performance for a tire tread of such rubber composition.

From Table 2, it is seen that for cured Experimental rubber Samples C and D containing the specialized styrene/butadiene rubber with its molecular weight profile, where rubber Sample D also contained the freely added soybean oil, their tan delta values at −20° C. of 0.64 and 0.55, respectively, were higher and lower than Comparative Sample A, which had a tan delta value of 0.59. However, the tan delta values for Experimental rubber Samples C and D were both lower than the tan delta value of Control rubber Sample B containing the conventional styrene/butadiene rubber.

Therefore, it is concluded that it has been discovered that the inclusion of the freely added soybean oil of Experimental rubber Sample D enabled the specialized styrene/butadiene elastomer containing rubber Sample C to achieve a beneficially improved predictive cold weather performance with a smaller percent detriment to predictive wet traction performance for a tire read of such rubber composition.

(3) The DIN abrasion relative volume loss is used as an indicator of treadwear performance. Lower values are considered better for predictive beneficial treadwear resistance and therefore extended tread life (sometimes referred to as treadwear performance) for a tire tread of such rubber composition.

It is concluded that, with lower values of the relative volume loss, based on the laboratory DIN abrasion test, which is considered as being better for predictive treadwear performance for a tire having a tread of such rubber composition that:
(a) Experimental rubber Samples C and D exhibited a reduced predictive treadwear performance compared to Comparative rubber Sample A but an improved predictive treadwear performance compared to Control rubber Sample B containing the conventional styrene/butadiene rubber.
(b) Experimental rubber Sample D containing the freely added soybean oil in addition to the specialized styrene/butadiene elastomer exhibited a significantly and beneficially reduced relative volume loss, and therefore an improved predictive treadwear performance compared to Experimental rubber Sample C with its freely added petroleum based processing oil as well as Control rubber Sample B containing the conventional styrene/butadiene rubber.

Therefore, it is concluded that it has been discovered that the inclusion of the freely added soybean oil of Experimental rubber Sample D enabled the specialized styrene/butadiene elastomer containing rubber Sample C to achieve a beneficially improved predictive treadwear performance as compared to both of Control rubber Sample B (containing the conventional styrene/butadiene rubber) and rubber Sample C.

While certain representative embodiments and details have been shown for the purpose of illustrating the invention, it will be apparent to those skilled in this art that various changes and modifications may be made therein without departing from the spirit or scope of the invention.

What is claimed is:

1. A pneumatic rubber tire having a component of a rubber composition containing, based on parts by weight per 100 parts by weight of the rubber (phr),
(A) conjugated diene-based elastomers comprised of:
(1) about 40 to about 90 phr of a specialized styrene/butadiene elastomer having a molecular weight profile comprised of a weight average molecular weight (Mw) in a range of from about 500,000 to about 800,000 with a low molecular weight content limited to a maximum of six percent of said styrene/butadiene elastomer having a number average molecular weight (Mw) of up to 150,000, and
(2) about 60 to about 10 phr of at least one additional conjugated diene-based elastomer,
(B) about 40 to about 160 phr of reinforcing filler comprised of a combination of rubber reinforcing carbon black and precipitated silica together with coupling agent is provided for said precipitated silica having a moiety reactive or interactive with hydroxyl groups (e.g. silanol groups) on said precipitated silica and another different moiety reactive or interactive with said diene-based elastomers,
(C) about 5 to about 70 phr of traction promoting resin, and
(D) about 15 to about 55 phr of rubber processing oil comprised of at least one triglyceride vegetable oil.

2. The tire of claim 1 wherein said reinforcing filler for said rubber composition is comprised of from about 10 to about 99.5 weight percent precipitated silica and from about 0.5 to about 90 weight percent rubber reinforcing carbon black.

3. The tire of claim 1 wherein said reinforcing filler for said rubber composition is comprised of at least 100 phr of precipitated silica and up to about 15 phr of rubber reinforcing carbon black.

4. The tire of claim 1 wherein the total of said traction promoting resin and rubber processing oil is greater than 50 phr.

5. The tire of claim 1 wherein the wherein the rubber composition contains about 9 to about 40 phr of said traction promoting resin and about 9 to about 40 phr of said rubber processing oil and the total of said traction promoting resin and said rubber processing oil is less than 50 phr.

6. The tire of claim 3 wherein the rubber composition contains about 9 to about 40 phr of said traction promoting resin and about 9 to about 40 phr of said rubber processing oil and the total of said traction promoting resin and said rubber processing oil up to 50 phr.

7. The tire of claim 6 wherein said rubber composition contains rubber processing oil comprised of a combination of freely added triglyceride vegetable oil and at least one of freely added petroleum-based rubber processing oil and petroleum-based rubber processing oil extended specialized styrene/butadiene elastomer.

8. The tire of claim 6 wherein said rubber composition contains rubber processing oil comprised of a combination of freely added triglyceride vegetable oil and petroleum-based rubber processing oil extended specialized styrene/butadiene elastomer.

9. The tire of claim 1 wherein the triglyceride vegetable oil of said rubber composition is comprised of at least one of soybean oil, sunflower oil, rapeseed oil.

10. The tire of claim 1 wherein the triglyceride vegetable oil of said rubber composition is comprised of soybean oil.

11. The tire of claim 1 wherein said coupling agent is comprised of an alkoxyorganomercaptosilane or bis(3-triethoxysilylpropyl) polysulfide having an average of from about 2 to about 4 connecting sulfur atoms in its polysulfidic bridge.

12. The tire of claim 1 wherein said precipitated silica and coupling agent are provided as a composite of said precipitated silica pre-treated with said coupling agent prior to addition thereof to the rubber composition.

13. The tire of claim 1 wherein said precipitated silica and coupling agent are provided with said rubber composition to provide an in situ treated precipitated silica with said coupling agent within said rubber composition.

14. The tire of claim 1 wherein said additional conjugated diene based elastomer is at least one of cis 1,4-polybutadiene, cis 1,4-polyisoprene, 3,4-polyisoprene and additional styrene/butadiene elastomer other than said specialized styrene/butadiene elastomer having said molecular weight profile.

15. The tire of claim 1 wherein said specialized styrene/butadiene elastomer is tin or silicon coupled.

16. The tire of claim 14 wherein said at least one of said additional and specialized styrene/butadiene elastomer is tin or silicon coupled.

17. The tire of claim 1 where said low molecular weight content of said specialized styrene/butadiene elastomers is a maximum of about 5.5 percent thereof having a weight average molecular weight (Mw) in a range of from about 1 to about 150,000.

18. The tire of claim 1 wherein said traction promoting resin is comprised of at least one of styrene-alphamethylstyrene resin, coumarone-indene resin, petroleum hydrocarbon resin, terpene polymer resin, terpene phenol resin, rosin derived resin, including gum rosin, and copolymers and phenol formaldehyde resin, including octylphenol formaldehyde.

19. The tire of claim 1 wherein said rubber composition is sulfur cured.

20. The tire of claim 1 wherein said tire component is a circumferential tire tread.
